(19) United States
(12) Patent Application Publication
(10) Pub. No.: US 2005/0022235 A1
(43) Pub. Date: Jan. 27, 2005

(54) Digital video broadcast network application

(76) Inventor: Steven L. Davis, Castle Rock, CO (US)

Correspondence Address: Bruce E. Hayden, Box 205, Dillon, CO, 80435-0205, US

(21) Appl. No.: 10/890,917

(22) Filed: Jul. 14, 2004

Related U.S. Application Data
(60) Provisional application No. 60/489,259, filed on Jul. 22, 2003.

(51) Int. Cl. H04N 5/445; G06F 3/00

(52) U.S. Cl. 725/39; 725/50

(57) ABSTRACT

A digital broadcasting network application for selectively broadcasting digital video, audio, graphics, and text comprises master broadcast transmitter software controlling the distribution of video content to remote receiver and display units. Master program scheduler software is utilized to automatically generate play lists, schedules, and delivery plans for the remote receiver and display units. Remote network receiver software executing on remote receiver and display units receive and capture video content transmitted to it from a master broadcast transmitter server. Remote program display manager software then interprets master program scheduler schedules and play lists and displays the captured content on associated displays without requirement of manual intervention at the remote site.

### RELATED APPLICATIONS

This application claims priority under 35 USC § 119(e) to U.S. Provisional Patent Application, Ser. No. 60/489,259, filed Jul. 22, 2003, incorporated herein by reference.

### FIELD OF THE INVENTION

The present invention generally relates to displaying digital video content, and, more specifically, to automatically scheduling, distributing, and playing of video, audio, graphics, text, and interactive content to multiple remote locations on fixed wire computers, mobile laptops in Wi-Fi environments, PDA's, and picture cell phones across the Internet, Broadband, or Satellite Networks.

### BACKGROUND OF THE INVENTION

Information has been manually distributed for millennia. Some examples of this have been Pony Express, railroads, and U.S. Mail carriers on foot. The media containing the information was primarily paper, and distribution was relatively slow, and it required vast amounts of manual intervention. Faster today, but still dependent on manual intervention, are services such as Federal Express, UPS, and USPS Express Mail. These methods still require considerable amounts of manual production and intervention for first delivery and updates. Information distribution is currently being automated, with FAX machines, E-mail, and Internet downloads. However, these methods are slow speed, limited in scope, reach, and capacity, and are unable to effectively deliver large video files.

Computers and computer video have become ubiquitous. As a result, there have been attempts to provide video displays in stores, malls, and other places of business. For example, a mall may display on video screens advertisements for various stores in the mall. Similarly, a store may have one or more video screens in various departments displaying advertising for merchandise in the departments. Homeland Defense may use fixed or mobile video displays as a means to inform agents at the Borders, Airports, Seaports or at critical facilities.

Unfortunately, the mechanism for providing this sort of video is currently very crude and inflexible. For example, various videos can be manually merged onto a VCR tape and the VCR tape is then repeatedly played, displaying those videos on associated screens. A little more flexible, compressed video files on a general purpose computer can be linked in a play list, which is repeatedly played in a loop, again resulting in displaying those videos on associated screens. This requires that the compressed video files be made available on a general purpose computer, and that the play list be manually generated and maintained. While this is feasible on a small scale, it is not feasible on a large scale, such as for a national chain of stores, due to the amount of manual intervention and computer skills required.

A system would thus be advantageous that automated creation of play lists and delivery of the video content. It would also be advantageous for play list and video schedule creation to be controllable at a centralized or regional national level, while allowing for local modification.

### BRIEF SUMMARY OF THE INVENTION

A digital broadcasting application system for selectively broadcasting digital video, audio, graphics, and text comprises master broadcast transmitter software controlling the distribution of video content to remote receiver and display units. Master program scheduler software is utilized to automatically generate play lists, schedules, and delivery plans for the remote receiver and display units. Remote network receiver software executing on remote receiver and display units receive and capture video content transmitted to it from a master broadcast transmitter server. Remote program display manager software then interprets master program scheduler schedules and play lists and displays the captured content on associated displays without requirement of manual intervention at the remote site.

### BRIEF DESCRIPTION OF THE DRAWINGS

FIG. 1 is a block diagram illustrating a General Purpose Computer, in accordance with one embodiment of the present invention;

FIG. 2 is a diagram illustrating an example of broadcasting digital video, in accordance with one embodiment of the present invention; and

FIG. 3 is a block diagram illustrating a sample digital broadcasting network for selectively broadcasting video, in accordance with one embodiment of the present invention.

### DETAILED DESCRIPTION OF THE INVENTION

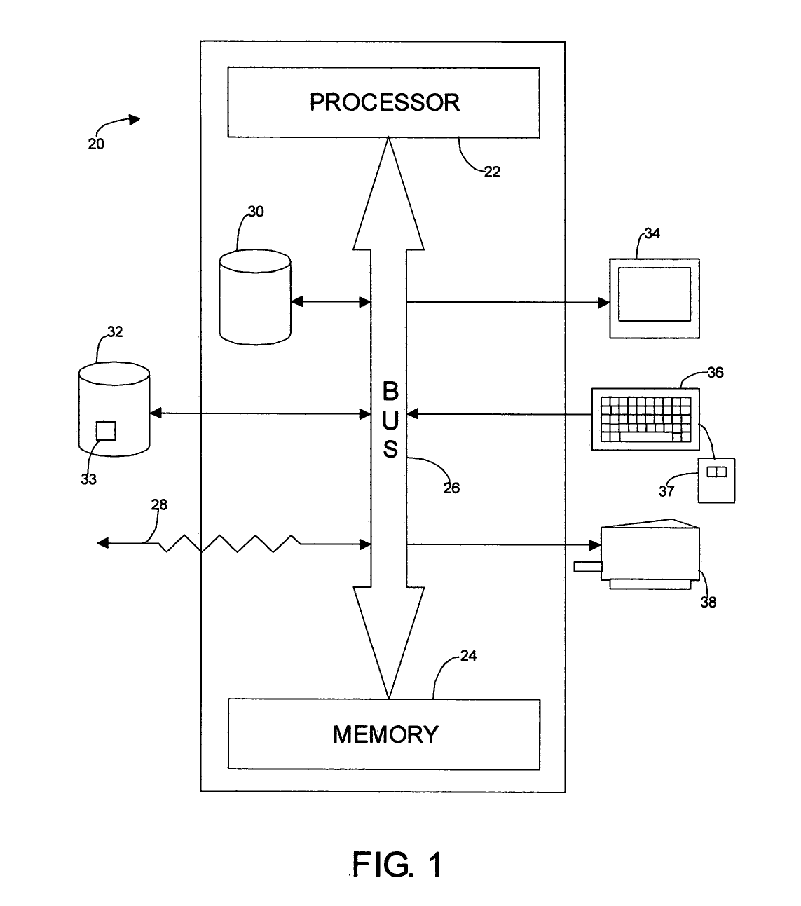

FIG. 1 is a block diagram illustrating a General Purpose Computer 20. The General Purpose Computer 20 has a Computer Processor 22, and Memory 24, connected by a Bus 26. Memory 24 is a relatively high speed machine readable medium and includes Volatile Memories such as DRAM, and SRAM, and Non-Volatile Memories such as, ROM, FLASH, EPROM, EEPROM, and bubble memory. Also connected to the Bus are Secondary Storage 30, External Storage 32, output devices such as a display 34, input devices such as a keyboard 36 with a mouse 37, and printers 38. Secondary Storage 30 includes machine-readable media such as hard disk drives, magnetic drum, and bubble memory. External Storage 32 includes machine-readable media such as floppy disks, removable hard drives, magnetic tape, CD-ROM, and even other computers, possibly connected via a communications line 28. The distinction drawn here between Secondary Storage 30 and External Storage 32 is primarily for convenience in describing the invention. As such, it should be appreciated that there is substantial functional overlap between these elements. Computer software such test programs, operating systems, and user programs as well as user data can be stored in a Computer Software Storage Medium, such as memory 24, Secondary Storage 30, and External Storage 32. Executable versions of computer software 33, such as video scheduling and display software can be read from a Non-Volatile Storage Medium such as External Storage 32, Secondary Storage 30, and Non-Volatile Memory and loaded for execution directly into Volatile Memory, executed directly out of Non-Volatile Memory, or stored on the Secondary Storage 30 prior to loading into Volatile Memory for execution. Computer Storage includes both a Non-Volatile Storage Media and Volatile Memory.

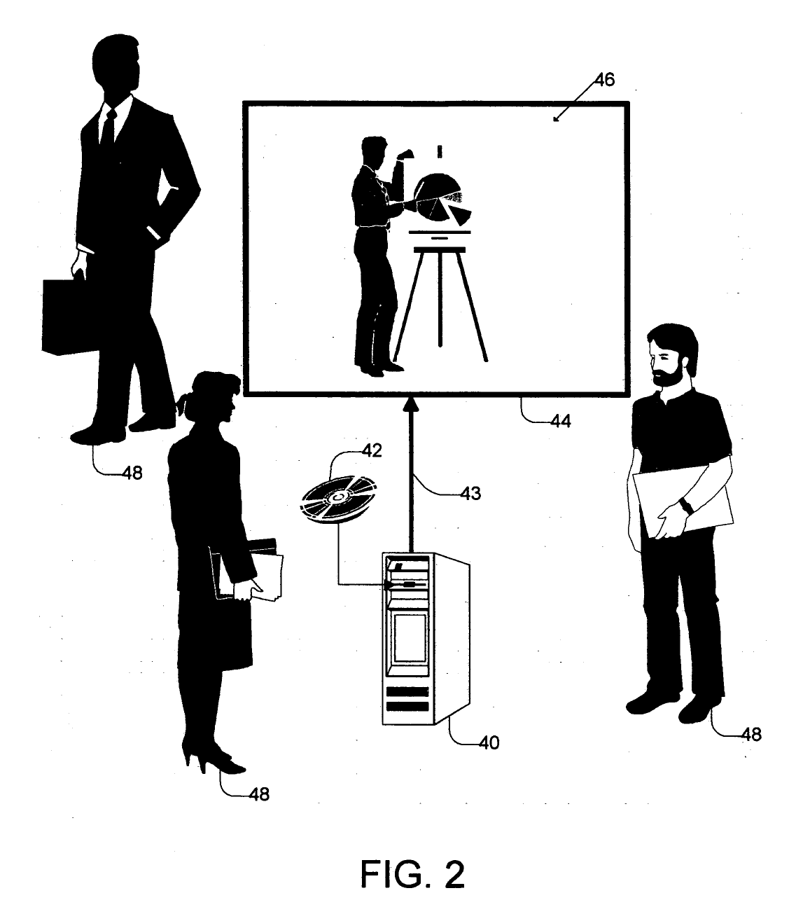

FIG. 2 is a diagram illustrating an example of broadcasting video. A remote receiver and display unit 40 is coupled to 43 and drives a display 44, displaying a video 46, typically input originally on a CD or a DVD 42, or downloaded from a server, to one or more viewers 48.

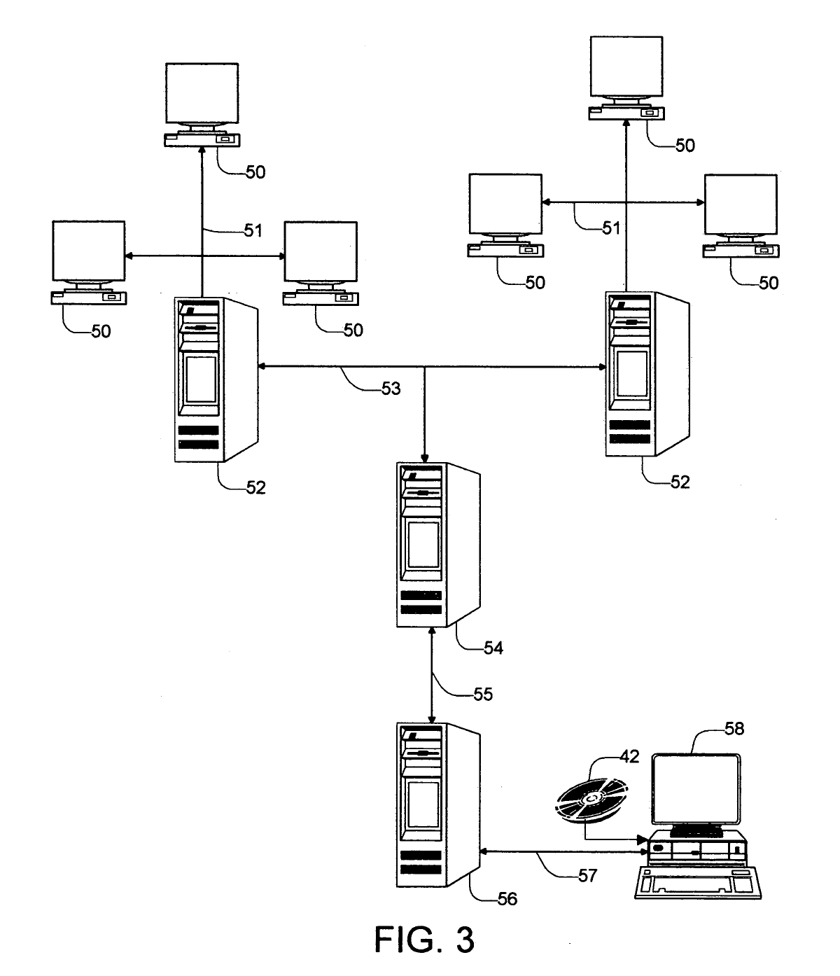

The remote receiver and display unit 40 may be a general purpose computer 20, such as a personal computer, or may be a “thin” box that contains sufficient components to drive a display 44 to display a video 46 received across a network (not shown, see FIG. 3), or any other computer like device providing such functionality. The remote receiver and display unit 40 executes remote network receiver software that receives and captures video content and remote program display software that plays that video content as directed.

In a typical application, videos 46 are received across a network and stored on a Non-Volatile Storage Medium in the remote receiver and display unit 40. At specified times various videos 46 are then read from the Non-Volatile Storage Medium and displayed on the display 44, typically in response to a play list. Storing videos 46 on the Non-Volatile Storage Medium and then playing them at such specified times has the advantage of minimizing network transfer time at a cost of storage. Videos 46 are typically received, stored, retrieved, and played in a compressed video form, such as JPEG.

In this embodiment, the display 44 is a flat screen display. However, it may be any type of display that can be driven by a computer 20 or other box containing computer like components. Some other examples are TV monitors, CPU monitors, LCD, plasma, video walls, and kiosks. The display 44 is typically utilized to display videos 46 to passing viewers 48. A single display 44 is shown coupled to and driven by a remote receiver and display unit 40. Note however that a single remote receiver and display unit 40 may drive multiple displays 44, either by splitting the display output from the remote receiver and display unit 40, or by utilizing multiple display outputs.

FIG. 3 is a block diagram illustrating a sample digital broadcasting network for selectively broadcasting digital video. This sample network can be viewed as having several levels: national, regional, store, and department. A store will typically comprise multiple departments. Stores are then organized into regions, and regions into a national network. This is exemplary, and other organizations are also within the scope of this invention.

The network within a remote location will typically comprise a facility level or local server 52 coupled 51 to a plurality of remote program display units 50. Remote program display units 50 typically comprise a remote receiver and display unit 40 coupled 43 to a display 44, as shown in FIG. 2. They may be coupled 51 to one or more local servers 52 via a wired network, such as Ethernet, or a wireless network, such as IEEE 802.11. Local servers 52 provide the remote program display units 50 with videos 46, typically in compressed form (such as JPEG), and directions for play of the videos 46. The videos 46 may be transmitted from a store server 52 each time they are played on a remote program display unit 50, or may be stored in a remote program display unit 50 for repeated display.

Local servers 52 are coupled to 53 and responsive to regional servers 54, which are in turn coupled to 55 and responsive to national servers 56. National servers 56 are coupled to 57 and responsive to a master program scheduler computer system 58, which is typically a general purpose computer 20.

An operator will typically utilize a master program scheduler computer system 58 to execute master program schedule software to schedule play of various videos 46 on various departmental remote program display units 50. Play (or playback) lists are automatically generated for the remote program display units 50 comprising video 46 identification and play times. Thus, a given play list may designate that video #1 will play in remote program display unit 50 starting at a specific time and running for a given duration. This would then be followed by video #2 for a second given duration, etc. It should be understood that videos 46 are typically repeated on a regular basis throughout a day for a period of time, such as a month. Thus, a given remote program display unit 50 may cycle through a series of twelve five minute videos each hour that a store is open for a month. During that month, these videos 46 are typically stored either in the remote program display units 50 and/or in the local servers 52. After the period that the videos are to be played, they would then typically be deleted, to be replaced by new programming. Locally storing videos 46 that are repeatedly played on remote program display units 50 significantly reduces the amount of data that needs to be transmitted to local servers 52.

As noted earlier, two different sets of data, videos 46 and play lists, are transmitted from national servers 56 to regional servers 54 to local servers 52. These two types of data have significantly different characteristics, and thus may be transmitted very differently. Videos 46 are relatively large files, but typically do not change very quickly. Thus, they may be delivered as bulk data. For example, they may be delivered over the Internet over night. Alternatively, they may be delivered on dedicated cable or satellite channels. Thus, a national server 56 or a regional server 54 may transmit a series of videos over such a channel. The local servers 52 would then typically receive the videos over the channel and store such videos as are scheduled over a given period of time in the future. Another alternative is to physically transfer videos 46 on removable media such as CDs, DVDs, or VCR tapes. Other methods of transferring videos 46 to the local servers 52 are also within the scope of this invention, including combinations of the above.

While a “push” type of transfer is discussed above, local servers 52 may also “pull” videos 46 from higher level servers based on play list requirements. Thus, for example, a local server 52 may download video files via FTP protocol across the internet that its remote program display units 50 will need to display, based on the next day's, week's or month's actual or projected play lists for these remote program display units 50.

Play lists on the other hand are typically much smaller files than the videos 46. Thus, they can be transmitted much more expeditiously. Play lists may be delivered for each location, region, group, groups of groups or by any classification associated with place, date and time, daily for the upcoming day, weekly for the upcoming week, etc. They may also be modified almost instantaneously, should that need arise. Other means and methods of transfer are also within the scope of this invention. While a “push” type of transfer is discussed above, store servers 52 may also “pull” play lists from higher level servers on a periodic basis.

Play lists are shown above being developed on national basis for each department in the country. This is not always optimal. Videos are expected to be often provided by vendors to a chain of stores. Different vendors will typically each provide their own videos. National vendors will typically often require national play of their videos in each appropriate department across the country. Thus, they may contract for their video to be shown once an hour while stores are open for a month. However, not all vendors are national, and local stores, and departments within stores, may have special promotions calling for special videos. For these reasons, in some embodiments, play lists can be modified at the regional, store, and department levels. One method of accomplishing this is to provide video play requirements to regional, store, and department levels, and then automatically generate play lists from these requirements. Another alternative is to provide a partial play list at the national level for each department. There would be holes in the partial play list that could be plugged with videos at the regional, store, or department levels or by device. Thus, as play lists migrate from the national level to the department level, they would fill in. Any remaining holes in the play lists could be plugged by repeating appropriate videos out of sequence

While the above shows distributing videos and play lists from the national level through the regional level to stores and departments, it will also often be advantageous to transmit actual play statistics in the opposite direction. Thus, a remote program display unit 50 may report that it played a specific video 46 at a particular time on a particular day. The display statistics for that video might then be accumulated and rolled up to higher and higher levels. This would allow a store chain to certify to its vendors that it had played that vendor's video(s) in the appropriate departments a certain number of times over a given period of time. The statistics gathered may be as detailed as required by the user of this invention and those providing it with videos.

This FIG. shows a four level hierarchy: national, regional, local (or store), and department. This is exemplary, and other hierarchies and organizations are also within the scope of this invention. Thus, a user of this invention may be organized with different countries, different states within a country, different regions within a state, and different stores within a region. On the other hand, it may be organized with national servers 56 being coupled to and directly controlling remote program display units 50. Other combinations are also within the scope of this invention.

The present invention utilizes four primary software components. Master broadcast transmitter software is a robust network distribution engine which notifies remote receiver and display units 40 when a new media package is ready for delivery. It comprises two primary software components: a network distribution engine for distributing media, and an interface for accepting requests from remote receiver and display units 40. The master broadcast transmitter software is typically executed on master broadcast transmitter servers, which include in FIG. 3, national servers 56, regional servers 54, and/or local servers 52.

A second software component comprises master program scheduler software. This software package is used to dynamically create schedules and delivery plans, content schedules and placement. It is used to create play (or playback) schedules based on date, time, location, sequence, groups, groups of groups, etc. Play lists and schedules are downloaded to (or retrieved by) remote receiver and display units 40. The master program scheduler software is shown executing on a master program scheduler computer system 58. However, this is exemplary, and other configurations are also within the scope of this invention. Two software packages typically execute on remote receiver and display units 40. Remote network receiver software receives and captures content transmitted to it from a master broadcast transmitter server. The content typically comprises videos and associated play lists. Remote program display manager software interprets master program scheduler schedules and play lists and displays the content on associated displays 44.

MPEG video compression is used in many current and emerging products. It is at the heart of digital television set-top boxes, DSS, HDTV decoders, DVD players, video conferencing, Internet video, and other applications. These applications benefit from video compression in the fact that they may require less storage space for archived video information, less bandwidth for the transmission of the video information from one point to another, or a combination of both.

The acronym “MPEG” stands for Moving Picture Expert Group, which worked to generate the specifications under ISO, the International Organization for Standardization and IEC, the International Electrotechnical Commission. What is commonly referred to as “MPEG video” actually consists at the present time of two finalized standards, MPEG-1 and MPEG-2, with a third standard, MPEG4, in the process of being finalized. The MPEG-1 & -2 standards are similar in basic concepts. They both are based on motion compensated block-based transform coding techniques. Other types of video compression are also within the scope of this invention.

The present invention provides increased speed through high speed fiber and satellite networks. It has global reach. It can deliver high capacity video to thousands of locations with intelligence with a single transmission. Typically, little, if any, manual intervention is required. There are not tapes or disks to produce, mail out, up load, etc. Content can be updated automatically based on date, time, location(s), region, brand, etc. Delivery can be guaranteed to the right location, displayed at the right time, in the right sequence, every time, providing significantly greater control.

Those skilled in the art will recognize that modifications and variations can be made without departing from the spirit of the invention. Therefore, it is intended that this invention encompass all such variations and modifications as fall within the scope of the appended claims.

1. A digital broadcasting network application for selectively broadcasting digital video comprising:
a master broadcast transmitter server containing master broadcast transmitter software for controlling a distribution of video content;
a master program scheduler computer system containing master program scheduler software for automatically generating a first play list; and
a first remote receiver and display unit that:
is coupled to the master broadcast transmitter server and the master program scheduler computer system; and
comprises:
a first display; and
a computer software storage medium containing remote network receiver software for capturing video content from the master broadcast transmitter server and remote program display manager software for interpreting the first play list and for displaying the captured content on the first display in response to the first play list.

2. The digital broadcasting network in claim 1 which further comprises:
a second remote receiver and display unit that:
is coupled to the master broadcast transmitter server and the master program scheduler computer system; and
comprises:
a first display; and
a computer software storage medium containing remote network receiver software for capturing video content from the master broadcast transmitter server and remote program display manager software for interpreting a second play list and for displaying the captured content on the first display in response to the second play list.

3. The digital broadcasting network in claim 1 wherein:
the first remote receiver and display unit further comprises a second display; and
the remote program display manager software further interprets the first play list and displays the captured content on the second display in response to the first play list.

4. The digital broadcasting network in claim 1 wherein:
the master program scheduler software automatically generates a second play list;
the first remote receiver and display unit further comprises a second display; and
the remote program display manager software further interprets the second play list and displays the captured content on the second display in response to the second play list.

5. The digital broadcasting network in claim 1 wherein:
the master program scheduler software further automatically generates a master program scheduler schedule; and
the remote program display manager software further interprets the master program scheduler schedule.

6. The digital broadcasting network in claim 1 wherein:
the master program scheduler software further automatically generates a video content delivery plan; and
video content is distributed to the first remote receiver and display unit from the master broadcast transmitter server in response to the video content delivery plan.

7. A remote receiver and display unit containing software that comprises computer instructions for:
receiving a video content from a master broadcast transmitter server;. and
storing the video content received from the master broadcast transmitter server on a non volatile storage medium.

8. The remote receiver and display unit in claim 7 wherein the software further comprises computer instructions for:
receiving a first play list from a master program scheduler computer system;
reading the video content from the non volatile storage medium; and
displaying the video content read from the non volatile storage medium under control of the first play list received from the master program scheduler computer system on a first display.

9. The remote receiver and display unit in claim 8 wherein the software further comprises computer instructions for:
receiving a second play list from the master program scheduler computer system;
reading the video content from the non volatile storage medium; and
displaying the video content read from the non volatile storage medium under control of the second play list received from the master program scheduler computer system on a second display.

10. The remote receiver and display unit in claim 7 wherein:
the video content is stored on the non volatile storage medium in a compressed format.

11. A master program scheduler computer system containing master program scheduler software comprising computer instructions for:
receiving a set of play list requirements;
automatically generating a first play list for a first remote receiver and display unit based on the set of play list requirements; and
transmitting the first play list to the first remote receiver and display unit.

12. The master program scheduler computer system in claim 11 containing master program scheduler software further comprising computer instructions for:
automatically generating a second play list for a second remote receiver and display unit based on the set of play list requirements; and
transmitting the second play list to the second remote receiver and display unit.

13. The master program scheduler computer system in claim 11 containing master program scheduler software further comprising computer instructions for:
automatically generating a second play list for the first remote receiver and display unit based on the set of play list requirements; and
transmitting the second play list to the first remote receiver and display unit, wherein the first play list is to control display of video content on a first display in the first remote receiver and display unit and the second play list is to control display of video content on a second display in the first remote receiver and display unit.

14. The master program scheduler computer system in claim 11 containing master program scheduler software further comprises computer instructions for automatically generating a master program scheduler schedule.

15. The master program scheduler computer system in claim 11 containing master program scheduler software further comprises computer instructions for automatically generating a video content delivery plan.

16. A master broadcast transmitter server containing master broadcast transmitter software for controlling a distribution of video content comprising computer instructions for:
transmitting a first digital video to a first remote receiver and display unit; and
transmitting a second digital video to a second remote receiver and display unit.

17. The master broadcast transmitter server in claim 16 wherein:
the first digital video is also the second digital video.

18. The master broadcast transmitter server in claim 16 wherein:
the first digital video is transmitted to the first remote receiver and display unit utilizing a dedicated satellite channel.

19. The master broadcast transmitter server in claim 16 wherein:
the first digital video is transmitted to the first remote receiver and display unit as bulk data.

20. The master broadcast transmitter server in claim 16 wherein:
the master broadcast transmitter software further comprises computer instructions for:
transmitting a third digital video to the first remote receiver and display unit, wherein:
the first digital video is to be displayed on a first display in the first remote receiver and display unit while the third digital video is to be displayed on a second display in the first remote receiver and display unit.
